(19) United States
(12) Patent Application Publication
(10) Pub. No.: US 2017/0230184 A1
(43) Pub. Date: Aug. 10, 2017

(54) GRANTING ACCESS THROUGH APP INSTANCE-SPECIFIC CRYPTOGRAPHY

(71) Applicant: eBay Inc., San Jose, CA (US)

(72) Inventors: Arumugam Alwarappan, San Jose, CA (US); Mallikarjuna Potta, San Jose, CA (US); Snezana Sahter, San Jose, CA (US); Madhu Chetuparambil, San Jose, CA (US)

(21) Appl. No.: 15/348,301

(22) Filed: Nov. 10, 2016

Related U.S. Application Data
(60) Provisional application No. 62/292,444, filed on Feb. 8, 2016.

(51) Int. Cl. H04L 9/32; H04L 9/06; H04L 29/06

(52) U.S. Cl. CPC H04L 9/3247; H04L 63/0428; H04L 9/0643; H04L 9/3242; H04L 63/06; G06F 2221/2151

(57) ABSTRACT

In one example embodiment, a system for registering an application installable on a client device is provided. The system comprises processors and a memory storing instructions that, when executed by at least one processor among the processors, cause the system to perform operations comprising, at least, registering the application at a consumer registry service; receiving, in association with a client device ID, a public key of a public-private key pair generated by the consumer registry service, the private key of the public-private key pair stored at a device management service; publishing the application, having the public key and associated client device ID, to an application store; and based on a user installation of the published application onto the client device, communicating with the installed application.

### CLAIM OF PRIORITY

This patent application claims the benefit of priority, under 35 U.S.C. Section 119(e), to Alwarappan et al, U.S. Provisional Patent Application Ser. No. 62/292,444, entitled “GRANTING ACCESS THROUGH APP INSTANCE SPECIFIC CRYPTOGRAPHY”, filed on Feb. 8, 2016 (Attorney Docket No. 2043.J84PRV), which is hereby incorporated by reference herein in its entirety.

### BACKGROUND

A native application (also termed an “app”) can be deployed on an end-user device. As an initial operation, the deployed application has to identify itself to a central database or publication platform (e.g., eBay, Amazon, or another online platform) in order to get information relating to listings, data, transactions, and so forth. One conventional way for an app to gain access to this information is to use an application identity or “app secret” in conjunction with the device user's name and password or token. One technical problem with the conventional way of encryption is that the secret has to be “baked into” the application and it is possible for hackers to hack the relevant keychain or even the app itself and obtain the secret. App secrets are typically easily accessible. They are shipped with apps and are sent over a network during token acquisition. A further technical problem is that the app secret may be common to very many applications and if stolen can be readily shared with many other fraudulent users across the globe. Unauthorized access to an app secret is a significant security risk. If it is lost, its strategic value may not be limited solely to one platform, but may affect many.

### BRIEF SUMMARY

Viewed broadly, the inventors have recognized that one technical solution to these technical problems can include providing a “unique secret” per instance of the application, not in a general way as before, and making the secret valid only for a given particular device. The secret is unique. The inventors provide a protocol to do this.

In one embodiment, the inventors allow valid (authorized) applications to go through a device registration process. The apps are initially shipped (deployed on a device) with a public key of a key pair. During device registration, a device signature is constructed, and a secret key is generated at the app side. The device signature is encrypted using the secret key and the secret key is encrypted using the public key. The encrypted payload is sent along with a clientId (user ID) and the encrypted secret key over the relevant network during app installation. The private key is stored on the server side securely in a data center. The outcome of the device registration process is that a publication platform or online entity issuing the app (or commissioning it), for example, will assign a unique deviceId and unique key for each instance of the app which is used during token acquisition.

The unique key is also stored in the data center securely. During token acquisition, the device signature is constructed and a Hash-based Message Authentication Code (HMAC) is calculated and sent over the relevant network to a token acquisition service. The token acquisition service validates the HMAC and issues a token back to the app.

Most conventional approaches in app-level cryptography include pre-installation in the app of the secrets, with the secrets being sent over a network to get the tokens to access the relevant services. An attacker can potentially easily place an heaps proxy, obtain the secrets, and possibly steal many tokens with which he or she can attack the associated services. The solution mentioned above addresses this issue, as the device registration assigns a unique key which is used during token acquisition per deviceId and clientId (i.e., in a specific instance of the app). Generating a new deviceId is not a trivial task and hence it is very difficult to generate more tokens to attack the service. Also, the app secrets are secured with this solution. As this example solution uses the app to put time stamps in the device signature and calculate an HMAC for the device signature, the token acquisition request payloads are unique all the time, and this can make replay attacks almost impossible.

### BRIEF DESCRIPTION OF THE DRAWINGS

In order more easily to identify the discussion of any particular element or act, the most significant digit or digits in a reference number refer to the figure number in which that element is first introduced. The same or similar elements may be referred to by the same, or different, reference numbers depending on the context in which the elements are described.

FIG. 1 is a block diagram illustrating a networked system, according to some example embodiments.

FIG. 2 is a block diagram showing the architectural details of a publication system, according to some example embodiments.

FIG. 3 is a block diagram illustrating a representative software architecture, which may be used in conjunction with various hardware architectures herein described.

FIG. 4 is a block diagram illustrating components of a machine, according to some example embodiments, able to read instructions from a machine-readable medium (e.g., a machine-readable storage medium) and perform any one or more of the methodologies discussed herein.

FIGS. 5-9 illustrate aspects of example processes in accordance with some embodiments.

### DETAILED DESCRIPTION

“CARRIER SIGNAL” in this context refers to any intangible medium that is capable of storing, encoding, or carrying instructions for execution by a machine, and includes digital or analog communications signals or other intangible media to facilitate communication of such instructions. Instructions may be transmitted or received over a network using a transmission medium via a network interface device and using any one of a number of well-known transfer protocols.

“CLIENT DEVICE” in this context refers to any machine that interfaces to a. communications network to obtain resources from one or more server systems or other client devices. A client device may be, but is not limited to, a mobile phone, desktop computer, laptop, portable digital assistant (PDA), smart phone, tablet, ultrabook, netbook, multi-processor system, microprocessor-based or programmable consumer electronics system, game console, set-top box, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and network coupling may include a Code Division Multiple Access (CDMA) connection, a Global System for Mobile communications (GSM) connection, or another type of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LIE) standard, others defined by various standard-setting organizations, other long range protocols, or other data transfer technology.

“COMPONENT” in this context refers to a device, physical entity, or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function or related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between or among such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm), in other example embodiments, the processors or processor-implemented components may be distributed across a number of geographic locations.

“MACHINE-READABLE MEDIUM” in this context refers to a component, device, or other tangible medium able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly', a “machine-readable medium” refers to a single storage apparatus or device, as well as “cloud-based” storage systems or storage networks that include multiple storage apparatus or devices. The term “machine-readable medium” excludes signals per se.

“PROCESSOR” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), or any combination thereof. A processor may further be a multi-core processor having two or more independent processors (sometimes referred to as “cores”) that may execute instructions contemporaneously.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2016, eBay Inc., All Rights Reserved.

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

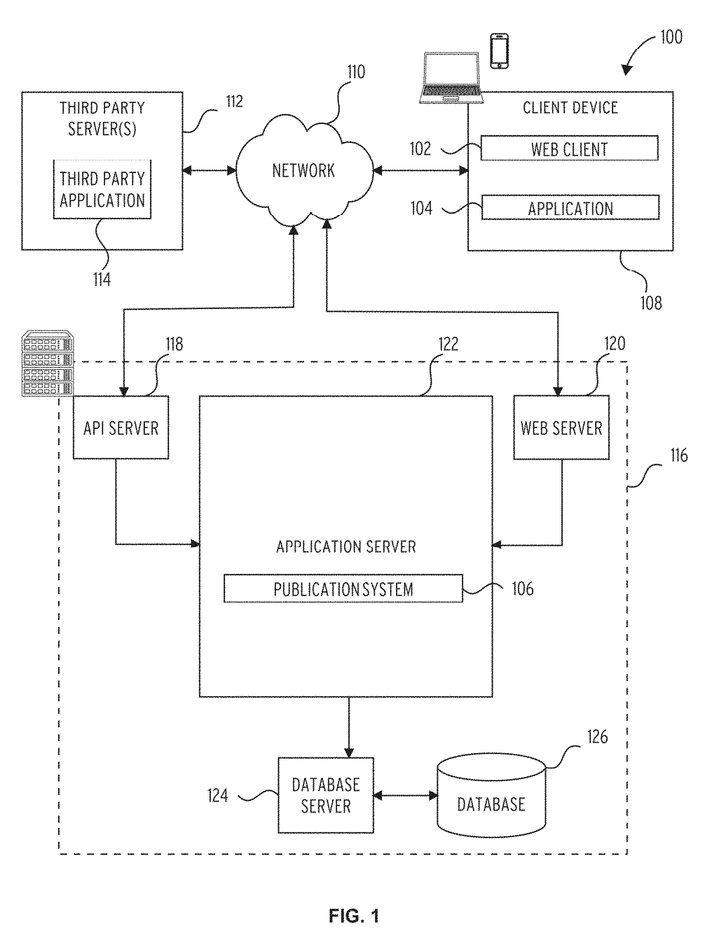

With reference to FIG. 1, an example embodiment of a high-level SaaS network architecture 100 is shown. A networked system 116 provides server-side functionality via a network 110 (e.g., the Internet or a WAN) to a client device 108. A web client 102 and a programmatic client, in the example form of an application 104, are hosted and execute on the client device 108. The networked system 116 includes an application server 122, which in turn hosts a publication system 106 that provides a number of functions and services to the application 104. The application 104 also provides a number of interfaces described herein, which present output of tracking and analysis operations to a user of the client device 108.

The client device 108 enables a user to access and interact with the networked system 116. For instance, the user provides input (e.g., touch-screen input or alphanumeric input) to the client device 108, and the input is communicated to the networked system 116 via the network 110. In this instance, the networked system 116, in response to receiving the input from the user, communicates information back to the client device 108 via the network 110 to be presented to the user.

An API server 118 and a web server 120 are coupled to, and provide programmatic and web interfaces respectively to, the application server 122. The application server 122 hosts the publication system 106, which includes components or applications. The application server 122 is, in turn, shown to be coupled to a database server 124 that facilitates access to information storage repositories (e.g., a database 126). In an example embodiment, the database 126 includes storage devices that store information accessed and generated by the publication system 106.

Additionally, a third-party application 114, executing on a third-party server 112, is shown as having programmatic access to the networked system 116 via the programmatic interface provided by the API server 118. For example, the third-party application 114, using information retrieved from the networked system 116, may support one or more features or functions on a website hosted by a third party.

Turning now specifically to the applications hosted by the client device 108, the web client 102 may access the various systems (e.g., publication system 106) via the web interface supported by the web server 120. Similarly, the application 104 (e.g., an “app”) accesses the various services and functions provided by the publication system 106 via the programmatic interface provided by the API server 118. The application 104 may, for example, be an “app” executing on the client device 108, such as an iOS or Android OS application to enable the user to access and input data on the networked system 116 in an off-line manner, and to perform batch-mode communications between the application 104 and the networked system 116.

Further, while the SaaS network architecture 100 shown in FIG. 1 employs a client-server architecture, the present inventive subject matter is of course not limited to such an architecture, and could equally well find application in a distributed, or peer-to-peer, architecture system, for example. The publication system 106 could also be implemented as a standalone software program, which does not necessarily have networking capabilities.

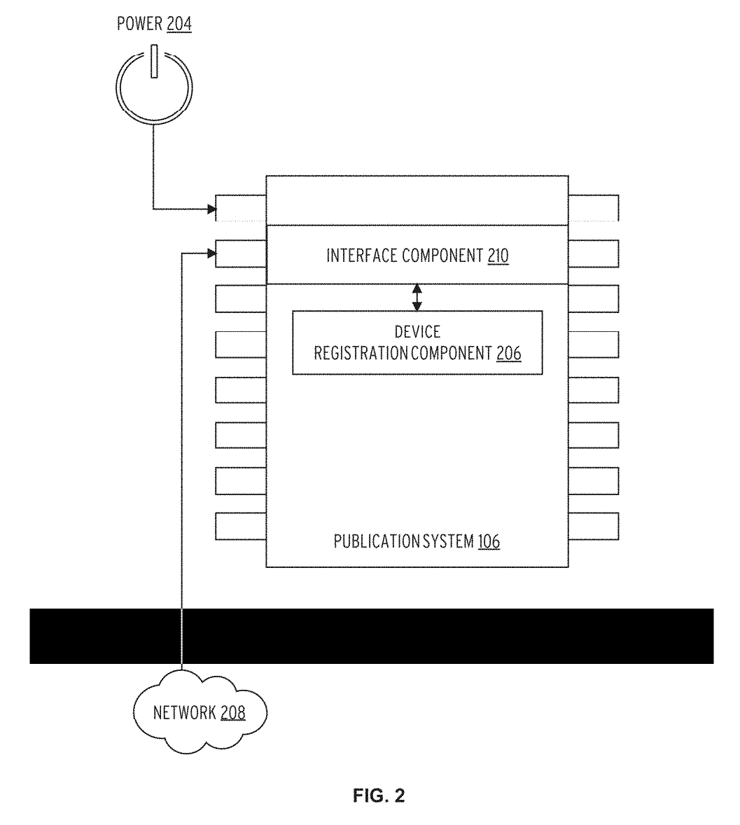

FIG. 2 is a block diagram showing the architectural details of a publication system 106, according to some example embodiments.

Specifically, the publication system 106 is shown to include an interface component 210 by which the publication system 106 communicates (e.g., over a network 208) with other systems within the SaaS network architecture 100.

The interface component 210 is collectively coupled to a device registration component 206 that operates in one example to assign a unique key which is used during token acquisition per deviceId and clientId (i.e., a specific instance of an app). The unique key is also stored in a data center (e.g., database 126) securely. During token acquisition, a device signature is constructed and a Hash-based Message Authentication Code (HMAC) is calculated and sent over the relevant network to a token acquisition service. The token acquisition service validates the HMAC and issues a token back to the app.

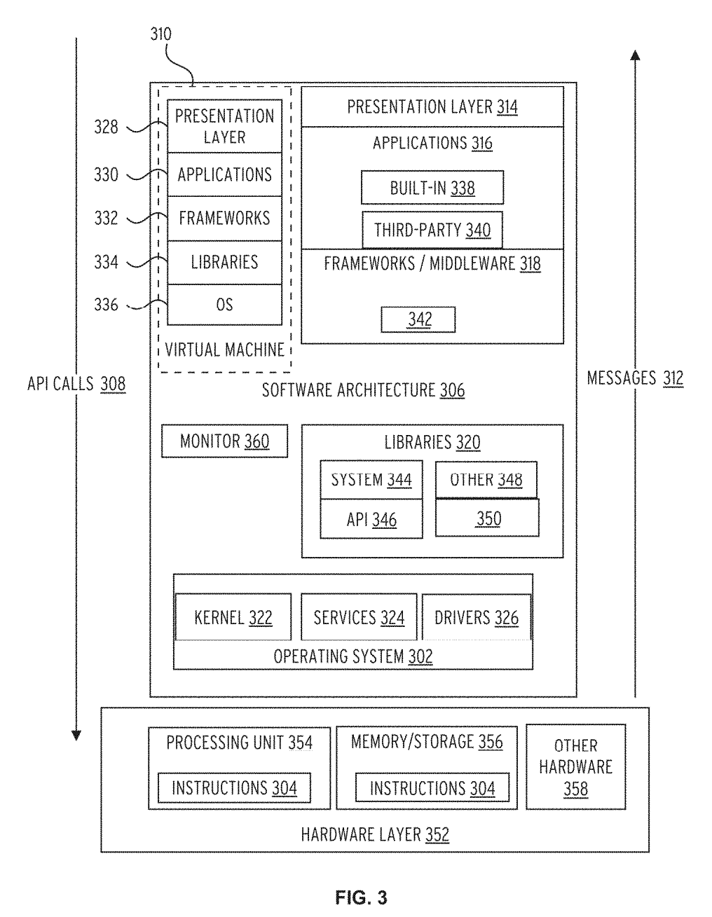

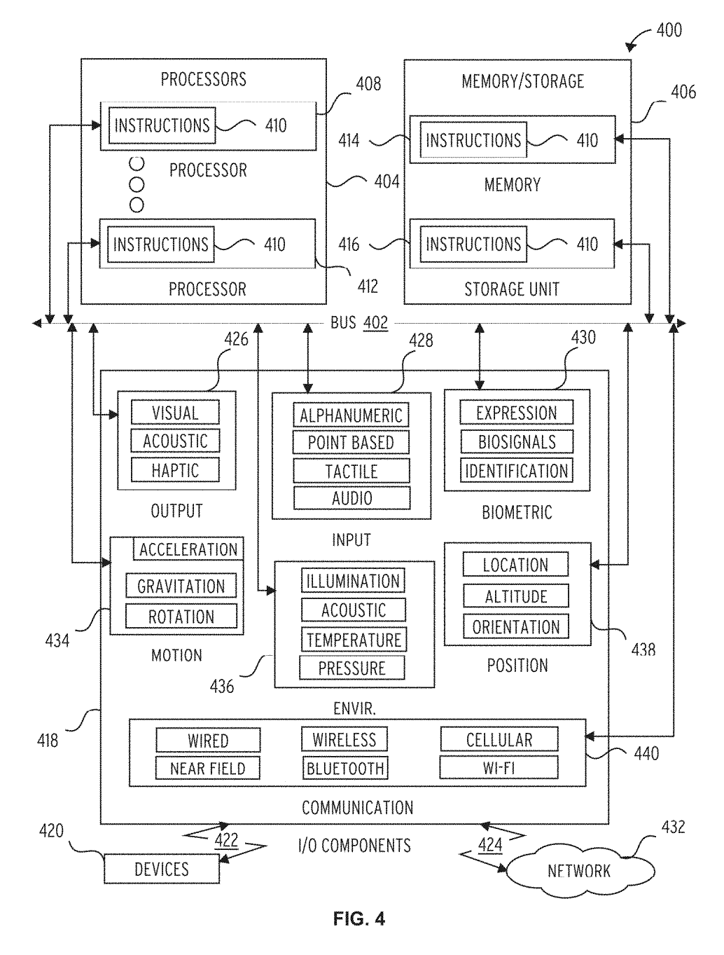

FIG. 3 is a block diagram illustrating an example software architecture 306, which may be used in conjunction with various hardware architectures herein described. FIG. 3 is a non-limiting example of a software architecture and it will be appreciated that many other architectures may be implemented to facilitate the functionality described herein. The software architecture 306 may execute on hardware such as a machine 400 of FIG. 4 that includes, among other things, processors 404, memory/storage 406, and I/O components 418. A representative hardware layer 352 is illustrated and can represent, for example, the machine 400 of FIG. 4. The representative hardware layer 352 includes a processing unit 354 having associated executable instructions 304. The executable instructions 304 represent the executable instructions of the software architecture 306, including implementation of the methods, components, and so forth described herein. The hardware layer 352 also includes memory and/or storage modules memory/storage 356, which also have the executable instructions 304. The hardware layer 352 may also comprise other hardware 358.

In the example architecture of FIG. 3, the software architecture 306 may be conceptualized as a stack of layers where each layer provides particular functionality. For example, the software architecture 306 may include layers such as an operating system 302, libraries 320, frameworks/middleware 318, applications 316, and a presentation layer 314. Operationally, the applications 316 and/or other components within the layers may invoke API calls 308 through the software stack and receive messages 312 in response to the API calls 308. The layers illustrated are representative in nature and not all software architectures have all layers. For example, some mobile or special-purpose operating systems may not provide a frameworks/middleware 318, while others may provide such a layer. Other software architectures may include additional or different layers.

The operating system 302 may manage hardware resources and provide common services. The operating system 302 may include, for example, a kernel 322, services 324, and drivers 326. The kernel 322 may act as an abstraction layer between the hardware and the other software layers. For example, the kernel 322 may be responsible for memory management, processor management (e.g., scheduling), component management, networking, security settings, and so on. The services 324 may provide other common services for the other software layers. The drivers 326 are responsible for controlling or interfacing with the underlying hardware. For instance, the drivers 326 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 320 provide a common infrastructure that is used by the applications 316 and/or other components and/or layers. The libraries 320 provide functionality that allows other software components to perform tasks in an easier fashion than to interface directly with the underlying operating system 302 functionality (e.g., kernel 322, services 324, and/or drivers 326). The libraries 320 may include system libraries 344 (e.g., C standard library) that may provide functions such as memory allocation functions, string manipulation functions, mathematical functions, and the like. In addition, the libraries 320 may include API libraries 346 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 320 may also include a wide variety of other libraries 348 to provide many other APIs to the applications 316 and other software components/modules.

The frameworks/middleware 318 provide a higher-level common infrastructure that may be used by the applications 316 and/or other software components/modules. For example, the frameworks/middleware 318 may provide various graphic user interface (GUI) functions, high-level resource management, high-level location services, and so forth. The frameworks/middleware 318 may provide a broad spectrum of other APIs that may be utilized by the applications 316 and/or other software components/modules, some of which may be specific to a particular operating system or platform.

The applications 316 include built-in applications 338 and/or third-party applications 340. Examples of representative built-in applications 338 may include, but are not limited to, a contacts application, a browser application, a book reader application, a location application, a media application, a messaging application, and/or a game application. The third-party applications 340 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 340 may invoke the API calls 308 provided by the mobile operating system (such as the operating system 302) to facilitate functionality described herein.

The applications 316 may use built-in operating system functions kernel 322, services 324, and/or drivers 326), libraries 320, and frameworks/middleware 318 to create user interfaces to interact with users of the system. Alternatively, or additionally, in some systems interactions with a user may occur through a presentation layer, such as the presentation layer 314. In these systems, the application/component “logic” can be separated from the aspects of the application/component that interact with a user.

Some software architectures use virtual machines. In the example of FIG. 3, this is illustrated by a virtual machine 310. The virtual machine 310 creates a software environment where applications/components can execute as if they were executing on a hardware machine (such as the machine 400 of FIG. 4, for example). The virtual machine 310 is hosted by a host operating system (operating system 302 in FIG. 3) and typically, although not always, has a virtual machine monitor 360, which manages the operation of the virtual machine 310 as well as the interface with the host operating system (i.e., operating system 302). A software architecture executes within the virtual machine 310, such as an operating system (OS) 336, libraries 334, frameworks 332, applications 330, and/or a presentation layer 328. These layers of software architecture executing within the virtual machine 310 can be the same as corresponding layers previously described or may be different.

FIG. 4 is a block diagram illustrating components of a machine 400, according to some example embodiments, able to read instructions from a machine-readable medium (e.g., a machine-readable storage medium) and perform any one or more of the methodologies discussed herein. Specifically, FIG. 4 shows a diagrammatic representation of the machine 400 in the example form of a computer system, within which instructions 410 (e.g., software, a program, an application, an applet, an app, or other executable code) for causing the machine 400 to perform any one or more of the methodologies discussed herein may be executed. As such, the instructions 410 may be used to implement modules or components described herein. The instructions 410 transform the general, non-programmed machine 400 into a particular machine 400 programmed to carry out the described and illustrated functions in the manner described. In alternative embodiments, the machine 400 operates as a standalone device or may be coupled (e.g., networked) to other machines, :In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (RDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 410, sequentially or otherwise, that specify actions to be taken by the machine 400. Further, while only a single machine 400 is illustrated, the term “machine” shall also be taken to include a collection of machines that individually or jointly execute the instructions 410 to perform any one or more of the methodologies discussed herein.

The machine 400 may include processors 404, memory/storage 406, and I/O components 418, which may be configured to communicate with each other such as via a bus 402. The memory/storage 406 may include a memory 414, such as a main memory, or other memory storage, and a storage unit 416, both accessible to the processors 404 such as via the bus 402. The storage unit 416 and memory 414 store the instructions 410 embodying any one or more of the methodologies or functions described herein. The instructions 410 may also reside, completely or partially, within the memory 414, within the storage unit 416, within at least one of the processors 404 (e.g., within the processor's cache memory), or any suitable combination thereof, during execution thereof by the machine 400. Accordingly, the memory 414, the storage unit 416, and the memory of the processors 404 are examples of machine-readable media.

The I/O components 418 may include a wide variety of components to receive input, provide output, produce output, transmit information, exchange information, capture measurements, and so on. The specific I/O components 418 that are included in a particular machine will depend on the type of machine. For example, portable machines such as mobile phones will likely include a touch input device or other such input mechanisms, while a headless server machine will not include such a touch input device. It will be appreciated that the I/O components 418 may include many other components that are not shown in FIG. 4. The I/O components 418 are grouped according to functionality merely for simplifying the following discussion and the grouping is in no way limiting. In various example embodiments, the I/O components 418 may include output components 426 and input components 428. The output components 426 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 428 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 418 may include biometric components 430, motion components 434, environment components 436, or position components 438 among a wide array of other components. For example, the biometric components 430 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 434 may include acceleration sensor components e.g., accelerometer), gravitation sensor components, rotation sensor components (e.g., gyroscope), and so forth. The environment components 436 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 438 may include location sensor components (e.g., a Global Position System (GPS) receiver component), altitude sensor components e.g., altimeters or barometers that detect air pressure from which altitude may be derived), orientation sensor components (e.g., magnetometers), and the like.

Communication may be implemented using a wide variety of technologies. The I/O components 418 may include communication components 440 operable to couple the machine 400 to a network 432 or devices 420 via a coupling 424 and a coupling 422 respectively. For example, the communication components 440 may include a network interface component or other suitable device to interface with the network 432. In further examples, the communication components 440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 420 may be another machine or any of a wide variety of peripheral devices (e.g., a peripheral device coupled via a USB).

Moreover, the communication components 440 may detect identifiers or include components operable to detect identifiers. For example, the communication components 440 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 440, such as location via Internet Protocol (IP) geolocation, location via Wi-Fi® signal triangulation, location via detecting an NFC beacon signal that may indicate a particular location, and so forth.

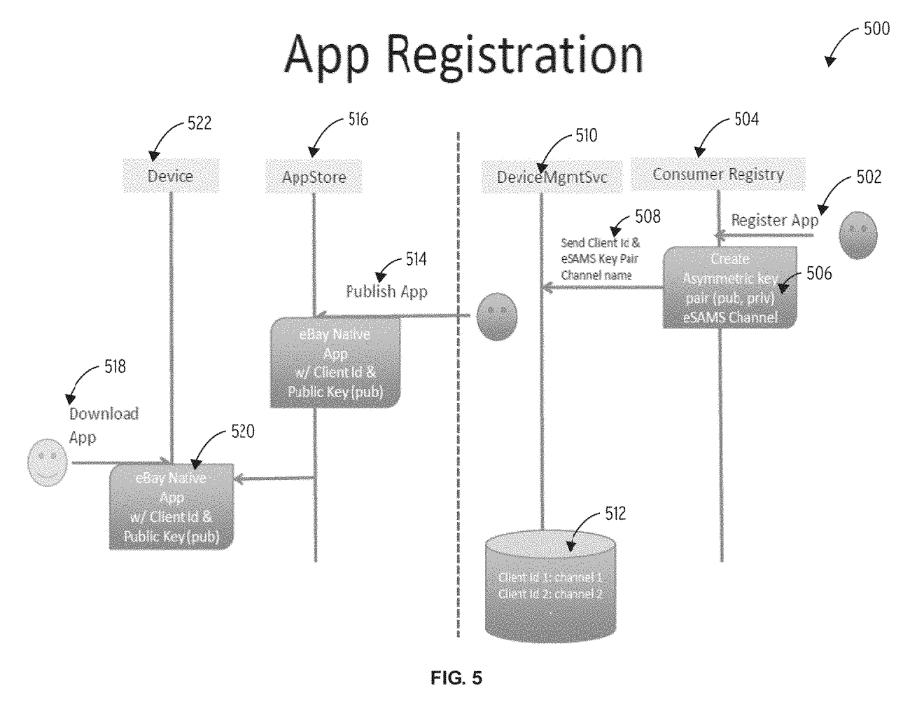

With reference to FIG. 5, an example of a protocol for mobile device identification (COS secure access) is given. The goal of device identification is to prevent fraud and secure app secrets. As discussed above, app secrets are conventionally easily accessible. They are shipped with apps and are sent over the wire (e.g., a network, or the Internet) during token acquisition.

One solution provided by the present disclosure includes shipping the apps with the public key of a key pair, encrypting the device signature with the on-the-fly generated secret, and encrypting the secret with a public key. The encrypted payload and key are sent over the wire during app installation. The private key is stored on the server side securely in a data center which may assign a unique key for each instance of the app which is used during token acquisition.

The mobile device on which the app is installed can be identified using 4PP techniques (e.g., an eBay identifier). Other techniques are possible. Platform identifiers can include iOS (IDFA, IDFV), Android (ADID, GDID), or Windows (WADID). Other platform identifiers are possible. Vendor identifiers can include ThreatMetrix (Smart Id, or Exact Id). Other vendor identifiers are possible.

FIG. 5 depicts an example app registration protocol or process 500. Example elements of the app registration process 500 are as shown. In one example, an app registers at operation 502 with a consumer registry service 504. The consumer registry service 504 generates at operation 506 a public-private key pair, returns the public key (of the pair) to the app, and sends at operation 508 the private key (of the pair) to a device management service 510. The device management service 510 retains the private key for the app (for example, {clientId, version}) in a database 512. The app with the public key and clientId is published at operation 514 to an app store 516. A user can download the app from the app store 516 at operation 518 and install at operation 520 the app (with the clientId and public key), on a device 522 (for example the client device 108 in FIG. 1).

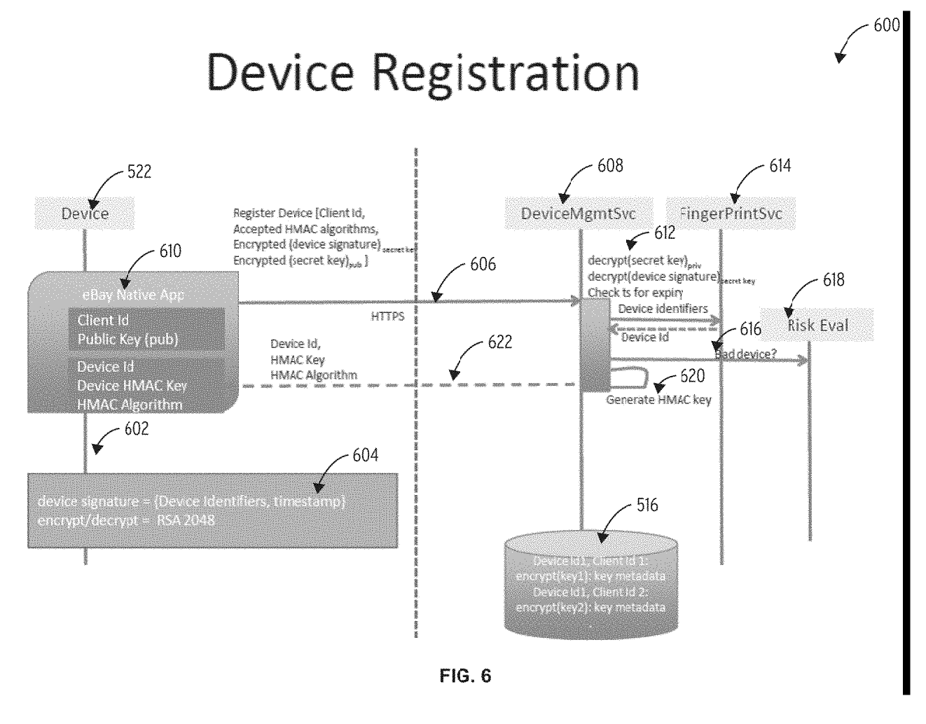

FIG. 6 depicts an example device registration process 600. Example elements of the device registration process 600 are as shown. The app installed on the device 522 as described above constructs at operation 602 a device signature 604 and encrypts the device signature 604 using the public key. The device signature 604 includes, in one example, a collection of device identifiers such as eBay or Amazon identifiers, mobile platform identifiers, etc., and the current timestamp on the device 522. Other device identifiers are possible. The app then sends at operation 606 the clientId, encrypted device signature 604, and device-supported HMAC algorithms (shown in element 610) to a device management service 608. The device management service 608 decrypts, at operation 612, the device signature using the private key assigned to the {clientId, version} and validates the timestamp in the decrypted device signature 604. If the decryption and validations are successful, the device management service 608 calls a device fingerprinting service 614 by sending the device identifiers for a device resolution. The device fingerprinting service 614 returns (as shown in dotted outline in FIG. 6) the deviceId to the device management service 608. The device management service 608 calls, at operation 616, a risk evaluation system 618 by passing the deviceId. The risk evaluation system 618 evaluates one or more security risks and sends a risk score back to the device management service 608. If the risk score is lower than identified thresholds, then the device management service 608 picks an algorithm from the support client HMAC algorithms (see element 610), generates in operation 620 an HMAC key for {clientId, deviceId}, and stores the HMAC key in its database 512. Then, the device management service 608 returns at operation 622 the HMAC key, deviceId, and HMAC algorithm to the app. The app stores the HMAC key, deviceId, and HMAC algorithm on the device 522.

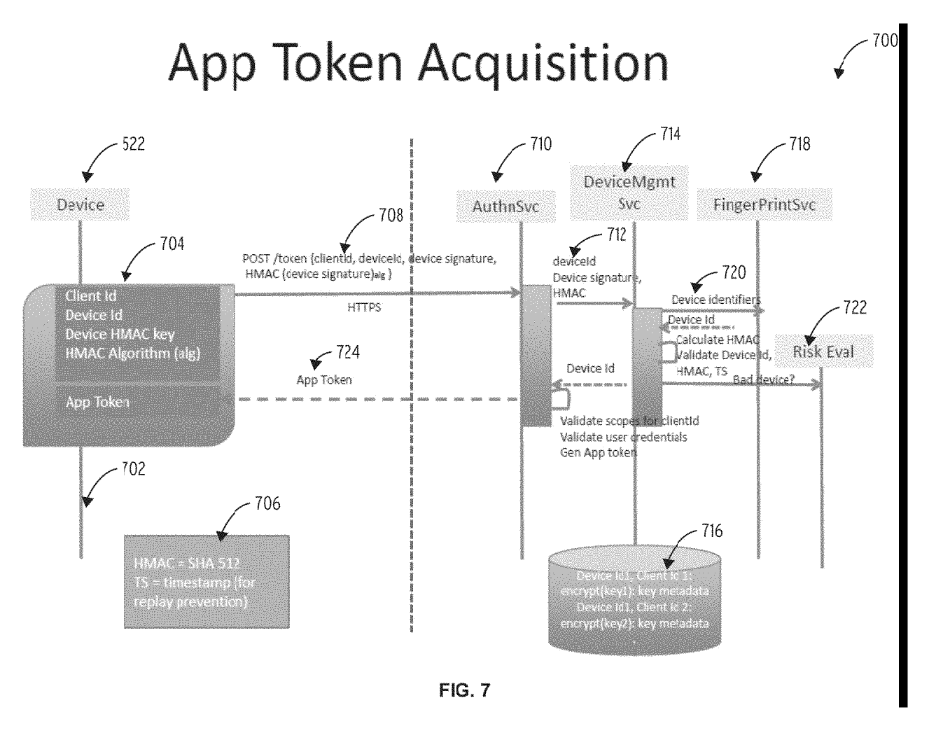

FIG. 7 depicts an example app token acquisition process 700. Example elements of the app token acquisition process 700 are as shown. The app installed on the device 522 constructs at operation 702 a device signature 706 and calculates an HMAC for the device signature 706 using an HMAC key and algorithm. The device signature 706 includes, in one example, a collection of device identifiers such as eBay or Amazon identifiers, mobile platform identifiers, etc., and the current timestamp on the device 522. Other device identifiers are possible. The app then sends at operation 708 the clientId, deviceId, device signature 706, and HMAC to an authentication (AuthN) service 710. The AuthN service 710 sends at operation 712. the clientId, deviceId, device signature 706, and HMAC to a device management service 714. The device management service 714 validates the timestamp existing in the device signature 706. The device management service 714 looks up the HMAC key for the {clientId, deviceId} from a database 716, calculates an HMAC for the device signature 706, and validates whether the calculated HMAC is the same as the HMAC in the request. If the validation is successful, the device management service 714 calls a device fingerprinting service 718 by sending the device identifiers at operation 720 for a device resolution. The device fingerprinting service 718 returns the deviceId (see dotted outline in FIG. 7) to the device management service 714. The device management service 714 compares the deviceId in the request with the deviceId in the response from the device fingerprinting service 718. If the deviceId matches, the device management service 714 calls a risk evaluation system 722 by passing the deviceId. The risk evaluation system 722 evaluates certain risk factors and sends a risk score back to the device management service 714. If the risk score is lower than certain thresholds, then the device management service 714 returns the deviceId to the AuthN service 710. The AuthN service 710 mints an app token for the {clientId, deviceId} and returns it at operation 724 to the app. The app retains the app token on the device 522.

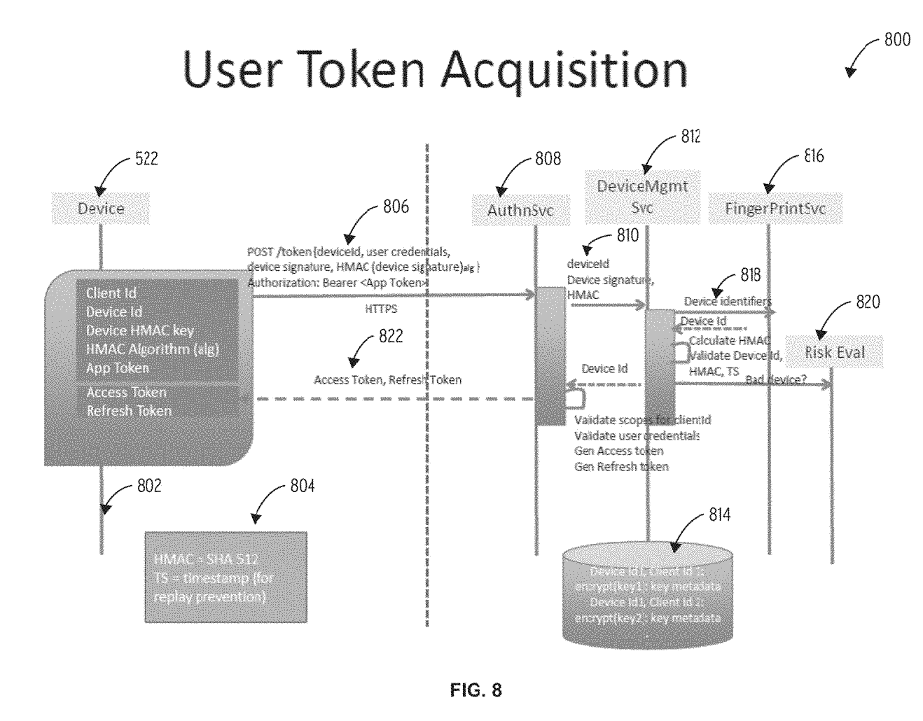

FIG. 8 depicts an example user token acquisition process 800. Example elements of the user token acquisition process 800 are as shown. The app installed on the device 522 constructs at operation 802 a device signature 804 and calculates an HMAC for the device signature 804 using an HMAC key and algorithm. The device signature 804 includes, in one example, a collection of device identifiers such as eBay or Amazon identifiers, mobile platform identifiers, etc., and the current timestamp on the device 522. Other device identifiers are possible. The app then sends at operation 806 the user credentials, clientId, deviceId, device signature 804, HMAC, and app token to an AuthN service 808. The AuthN service 808 sends at operation 810 the clientId, deviceId, device signature 804, and HMAC to a device management service 812. The device management service 812 validates the timestamp existing in the device signature 804. The device management service 812 then looks up the HMAC key for the {clientId, deviceId} from a database 814, calculates an HMAC for the device signature 804, and validates whether the calculated HMAC is the same as the HMAC in the request. If the validation is successful, the device management service 812 calls a device fingerprinting service 816 by sending in operation 818 the device identifiers for a device resolution. The device fingerprinting service 816 returns the deviceId to the device management service 812. The device management service 812 compares the deviceId in the request with the deviceId in the response from the device fingerprinting service 816. If the deviceId matches, the device management service 812 calls a risk evaluation system 820 by passing the deviceId. The risk evaluation system 820 evaluates certain risk factors and sends a risk score back to the device management service 812. If the risk score is lower than identified thresholds, the device management service 812 then returns the deviceId to the AuthN service 808. The AuthN service 808 validates the user credentials, mints a refresh token and user token for the {clientId, deviceId, userId}, and returns them at operation 822 to the app. The app retains the refresh token and user token on the device 522.

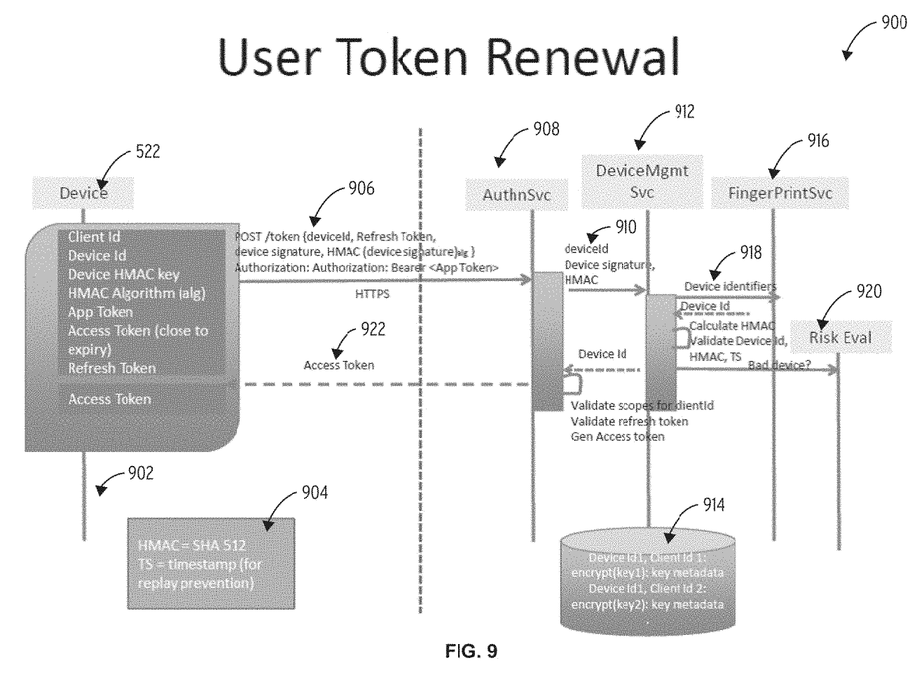

FIG. 9 depicts an example user token renewal process 900. Example elements of the user token renewal process 900 are as shown. The app installed on the device 522 constructs at operation 902 a device signature 904 and calculates the HMAC for the device signature 904 using an HMAC key and algorithm. The device signature 904 includes, in one example, a collection of device identifiers such as eBay or Amazon identifiers, mobile platform identifiers, etc., and the current timestamp on the device 522. Other device identifiers are possible. The app then sends at operation 906 the refresh token, clientId, deviceId, device signature 904, HMAC, and app token to an AuthN service 908. The AuthN service 908 sends at operation 910 the clientId, deviceId, device signature 940, and HMAC to a device management service 912. The device management service 912 validates the timestamp existing in the device signature 904. The device management service 912 then looks up the HMAC key for the {clientId, deviceId} from a database 914, calculates an HMAC for the device signature 904, and validates whether the calculated HMAC is the same as the HMAC in the request. If the validation is successful, the device management service 912 calls a device fingerprinting service 916 by sending in operation 918 the device identifiers for a device resolution. The device fingerprinting service 916 returns the deviceId to the device management service 912. The device management service 912 compares the deviceId in the request with the deviceId in the response from the device fingerprinting service 916. If the deviceId matches, the device management service 912 then calls a risk evaluation system 920 by passing the deviceId. The risk evaluation system 920 evaluates certain risk factors and sends a risk score back to the device management service 912. If the risk score is lower than identified thresholds, the device management service 912 then returns the deviceId to the AuthN service 908. The AuthN service 908 validates the app token and refresh token, mints a user access token for the {clientId, deviceId, userId}, and returns it at operation 922 to the app. The app retains the user access token on the device 522.

In some other examples, a two-factor authentication (also termed 2FA herein) token is used after transmitting the initial token to the user device. The 2FA token is generated using the previously generated token, the deviceiD, and a hash value (herein also referred to as “HMAC”). The 2FA token is also only valid for a certain configurable period of time (e.g., 15 minutes). The app periodically (e.g., every 15 minutes) profiles the device, constructs the device signature, and calls a device 2FA token service with clientId, device signature, HMAC, and user token. The device 2FA token service fetches the deviceId from the user token and sends the clientId, deviceId, device signature, and HMAC to a device management service. The device management service validates the timestamp that exists in the device signature. The device management service then looks up the HMAC key for the {clientId, deviceId} from a database, calculates an HMAC for the device signature, and validates whether the calculated HMAC is the same as the HMAC in the request. If the validation is successful, the device management service calls a device fingerprinting service by sending the device identifiers for a device resolution. The device fingerprinting service returns the deviceId to the device management service. The device management service compares the deviceId in the request with the deviceId in the response from the device fingerprinting service. If the deviceId matches, the device management service calls a risk evaluation system by passing the deviceId. The risk evaluation system evaluates one or more risk factors and sends a risk score back to the device management service. If the risk score is lower than applicable thresholds, the device management service then returns the deviceId to the device 2FA token service. The device 2FA token service generates a 2FA token and sends it as part of a response to the app. If the device management service validation “fails” (and hence doesn't return a deviceId in its response), then the device 2FA token service blacklists the 2FA token. In one example, the device management service maintains a list of 2FA tokens (normal and blacklisted) for each {clientId, deviceId} combination. The app retains the 2FA token on the device. The app maintains only the latest 2FA token. For all services, the app sends the 2FA token as part of a request header. A request handler in the services pipeline validates the 2FA token against the list of 2FA tokens for {clientId, deviceId}. If the 2FA token is blacklisted or it does not exist in the normal list, the handler blocks the request. Otherwise, the handler removes all the previously generated normal tokens, to the 2FA token in the request header, for {clientId, deviceId}, such that only the recently generated normal 2FA token exists for {clientId, deviceId}.

Example devices on or with which the described processes can be employed may include widgets, browser apps, and wearables. Other devices are possible. Example use cases may include user token renewal, fraud prevention across apps, rate limitation, identity tracking, personalization, and session transfer across devices.

What is claimed is:

1. A computer-implemented method for registering an application installable on a client device, the method comprising:
by one or more processors, registering the application at a consumer registry service;
by the one or more processors, receiving, in association with a client device ID, a public key of a public-private key pair generated by the consumer registry service, a private key of the public-private key pair stored at a device management service;
by the one or more processors, publishing the application, having the public key and the associated client device ID, to an application store; and
by the one or more processors, based on a user installation of the published application onto the client device, communicating with the installed application.

2. The method of claim 1, wherein the installed application is configured to construct a device signature and encrypt the device signature using the public key.

3. The method of claim 2, wherein the device signature includes, at least:
one or more device identifiers including a market identifier or a mobile platform identifier; and
a time stamp.

4. The method of claim 3, wherein the installed application is further configured to send the encrypted device signature to the device management service for decryption using the private key and validation of the time stamp.

5. The method of claim 4, further comprising receiving a validation from a fingerprinting service based on a device resolution using the one or more device identifiers.

6. The method of claim 4, wherein the installed application is further configured to receive, based at least on generation of an algorithm by the device management service, an HMAC key, the client device ID, and an HMAC algorithm for storing on the client device.

7. A system for registering an application installable on a client device, the system comprising:
processors; and
a memory storing instructions that, when executed by at least one processor among the processors, cause the system to perform operations comprising, at least:
registering the application at a consumer registry service;
receiving, in association with a client device ID, a public key of a public-private key pair generated by the consumer registry service, a private key of the public-private key pair stored at a device management service;
publishing the application, having the public key and the associated client device ID, to an application store; and
based on a user installation of the published application onto the client device, communicating with the installed application.

8. The system of claim 7, wherein the installed application is configured to construct a device signature and encrypt the device signature using the public key.

9. The system of claim 8, wherein the device signature includes, at least:
one or more device identifiers including a market identifier or a mobile platform identifier; and
a time stamp.

10. The system of claim 9, wherein the installed application is further configured to send the encrypted device signature to the device management service for decryption using the private key and validation of the time stamp.

11. The system of claim 10, wherein the operations further comprise receiving a validation from a fingerprinting service based on a device resolution using the one or more device identifiers.

12. The system of claim 10, wherein the installed application is further configured to receive, based at least on generation of an algorithm by the device management service, an HMAC key, the client device ID, and an HM AC algorithm for storing on the client device.

13. A non-transitory machine-readable medium including instructions that, when read by a machine, cause the machine to perform operations comprising, at least:
registering an application at a consumer registry service;
receiving, in association with a client device ID, a public key of a public-private key pair generated by the consumer registry service, a private key of the public-private key pair stored at a device management service;
publishing the application, having the public key and the associated client device ID, to an application store; and
based on a user installation of the published application onto a client device, communicating with the installed application.

14. The medium of claim 13, wherein the installed application is configured to construct a device signature and encrypt the device signature using the public key.

15. The medium of claim 14, wherein the device signature includes, at least:
one or more device identifiers including a market identifier or a mobile platform identifier; and
a time stamp.

16. The medium of claim 15, wherein the installed application is further configured to send the encrypted device signature to the device management service for decryption using the private key and validation of the time stamp.

17. The medium of claim 16, wherein the operations further comprise receiving a validation from a fingerprinting service based on a device resolution using the one or more device identifiers.

18. The medium of claim 16, wherein the installed application is further configured to receive, based at least on generation of an algorithm by the device management service, an HMAC key, the client device ID, and an HMAC algorithm for storing on the client device.
